(19) United States
(12) Patent Application Publication
(10) Pub. No.: US 2025/0371087 A1
(43) Pub. Date: Dec. 4, 2025

(54) METHODS, APPARATUSES AND COMPUTER PROGRAM PRODUCTS FOR PROVIDING TAILORED ONLINE CONTENT GENERATION

(71) Applicant: Meta Platforms, Inc., Menlo Park, CA (US)

(72) Inventors: Hadi Michel Salem, New York, NY (US); Kaolin Imago Fire, Berkeley, CA (US); Joshua David Burton, Tenafly, NJ (US); Ed Ignatius Tanghal Salvana, Burlingame, CA (US); Laura Michelle Warne, Sydney (AU); Rebecca Chahrzad Shapiro Kogen, Los Angeles, CA (US); Cem Kacmaz, New York, NY (US)

(21) Appl. No.: 19/217,431

(22) Filed: May 23, 2025

Related U.S. Application Data
(60) Provisional application No. 63/654,823, filed on May 31, 2024.

(51) Int. Cl. G06F 16/9535; G06F 16/9538

(52) U.S. Cl. CPC G06F 16/9535; G06F 16/9538

(57) ABSTRACT

Systems and methods to generate tailored content of a user are provided. The system may receive a set of attributes associated with a user. The set of attributes may be indicative of user interests based on content consumption of the user. The system may generate, via a machine learning model, tailored content including a visual representation of a set of content characteristics determined based on the set of attributes. The machine learning model may utilize training data including content items of the set of content characteristics. The system may display, by a user interface, the tailored content tailored to the user.

### CROSS-REFERENCE TO RELATED APPLICATIONS

This application claims priority to U.S. Provisional Application No. 63/654,823, filed May 31, 2024, entitled “Tailored Online Content Generation,” which is incorporated by reference herein in its entirety.

### TECHNOLOGICAL FIELD

Examples of the present disclosure relate to systems, methods, apparatuses, and computer program products for generating personalized online content.

### BACKGROUND

Online content feeds may provide sources of entertainment and information to users. Content feeds may be provided on various website types, such as social media sites, and allow users to continuously scroll through content. Users may interact with content feeds to, for example, pass time, catch up on news, or connect with friends, family, and colleagues. Some existing content feeds rank from fixed, and sometimes limited, connected inventory. As a result, when user's browse their content feeds may become increasingly reliant on unconnected content that is often lower quality and of lower interest. This may lead to user frustration, lack of interest, e.g., due to irrelevant content, and decreased content feed interactions. Accordingly, improved techniques may be needed to address present drawbacks.

### BRIEF SUMMARY

In meeting the described challenges, examples of the present disclosure provide systems, methods, devices, and computer program products for generating personalized online content. Various examples may include systems and methods for receiving a set of attributes associated with a user, generating, via a trained machine learning (ML) model, tailored content including a visual representation of a set of content characteristics influenced by the set of attributes, and displaying, on a graphical user interface, the tailored content in a content feed associated with the user. In examples, the set of attributes may be indicative of user interests based on content consumption of the user.

In some example aspects of the present disclosure, systems and methods to generate tailored content of a user are provided. The tailored content may be based on a set of attributes associated with a user and a set of content characteristics. The set of attributes may be indicative of user interests based on content consumption associated with the user. The tailored content may include a visual representation of the set of content characteristics influenced by the set of attributes. The tailored content may be displayed on a graphical user interface, in a content feed associated with the user. In examples, one or more machine learning models may be utilized to process at least one of the set of attributes and the set of content characteristics to generate the visual representation.

In examples, systems and methods may include applying a machine learning model to process the set of attributes and a set of content characteristics and to generate the visual representation. The machine learning model may be trained on content generated based on a set of recipes, each of the set of recipes may define a different set of content characteristics to characterize the visual representation. The machine learning model may also process the set of attributes and the set of content characteristics and may generate the visual representation. Tailored content may be used to re-train the machine learning model.

In various examples, systems and methods may include generating a second tailored content in response to user input at the graphical user interface. The second tailored content comprises at least one variation of the tailored content. Updated tailored content may be initiated in response to user input received at the graphical user interface. In some examples, the user input may include one or more of gesture(s), swipe(s) (e.g., left swipe, right swipe, up swipe, down swipe, etc.), selection(s), tap(s), pattern(s), audio input(s) (e.g., voice input(s), voice-activated feature(s)), or any other type, method, or manner in which user input may be received as user content. Various aspects may also provide a selection on the content feed to update the tailored content, and in response to initiating the selection, updating the tailored content by incorporating a new content characteristic into the visual representation. In yet another example, the selection may provide at least one of a prompt indicating at least one modification to the tailored content, or a box to receive information, entered at the graphical user interface, describing the at least one modification of/to the tailored content.

According to various aspects, the set of content characteristics may be defined in response to user input at the graphical user interface. The set of content characteristics may include one or more of: a time period, a place, an aesthetic, an interest, a character, and a cultural moment. The set of content characteristics may be selected from a plurality of recipes, each defining a different set of content characteristics. The visual representation may include at least one of: an image, a video, a color scheme, or a social media post. The content consumption may be associated with social media activity, such as social media activity associated with the user.

In another example of the present disclosure, a computer program product is provided. The computer program product may include at least one non-transitory computer-readable medium including computer-executable program code instructions stored therein. The computer-executable program code instructions may include program code instructions causing receiving a set of attributes associated with a user. The set of attributes may be indicative of user interests based on content consumption of the user. The computer-executable program code instructions may include program code instructions causing generating tailored content comprising a visual representation of a set of content characteristics influenced by the set of attributes, and displaying, on a graphical user interface, the tailored content in a content feed associated with the user.

The computer program product may further include program code instructions to further cause updating the tailored content by incorporating a new content characteristic into the visual representation. In another example, the instructions of the computer program product may further cause training a machine learning model with content generated based on a set of recipes. Each recipe of the set of recipes may define a different set of content characteristics to characterize the visual representation. The computer program product may further include program code instructions to further cause applying the machine learning model to process the set of attributes and the set of content characteristics and to generate the visual representation. The machine learning model may be re-trained using the tailored content.

In one example aspect of the present disclosure, a method is provided. The method may include receiving a set of attributes associated with a user. The set of attributes may be indicative of user interests based on content consumption of the user. The method may generate, via a machine learning model, tailored content including a visual representation of a set of content characteristics determined based on the set of attributes. The machine learning model may utilize training data including content items of the set of content characteristics. The method may include displaying, by a user interface, the tailored content tailored to the user.

In another example of the present disclosure, an apparatus is provided. The apparatus may include one or more processors and a memory including computer program code instructions. The memory and computer program code instructions are configured to, with at least one of the processors, cause the apparatus to at least perform operations including receiving a set of attributes associated with a user. The set of attributes may be indicative of user interests based on content consumption of the user. The memory and computer program code are also configured to, with the processor(s), cause the apparatus to generate, via a machine learning model, tailored content including a visual representation of a set of content characteristics determined based on the set of attributes. The machine learning model may utilize training data including content items of the set of content characteristics. The memory and computer program code are also configured to, with the processor(s), cause the apparatus to display, by a user interface, the tailored content tailored to the user.

In yet another example of the present disclosure, a computer program product is provided. The computer program product may include at least one non-transitory computer-readable medium including computer-executable program code instructions stored therein. The computer-executable program code instructions may include program code instructions configured to receive a set of attributes associated with a user. The set of attributes may be indicative of user interests based on content consumption of the user. The computer program product may further include program code instructions configured to generate, via a machine learning model, tailored content including a visual representation of a set of content characteristics determined based on the set of attributes. The machine learning model may utilize training data including content items of the set of content characteristics. The computer program product may further include program code instructions configured to facilitate display, by a user interface, of the tailored content tailored to the user.

Additional advantages will be set forth in part in the description which follows or may be learned by practice. The advantages may be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the present disclosure; however, the disclosed subject matter is not limited to the specific methods, compositions, and devices disclosed. In addition, the drawings are not necessarily drawn to scale. In the drawings:

FIG. 1 illustrates an example interface, in accordance with various aspects discussed herein.

FIG. 2 illustrates example recipes containing content characteristics, in accordance with various aspects discussed herein.

FIG. 3 illustrates a diagram for data processing and network communications, in accordance with various aspects discussed herein.

FIG. 4 illustrates a flowchart for generating tailored content, in accordance with various aspects discussed herein.

FIG. 5 illustrates a flowchart of operations for a machine learning model, in accordance with various aspects discussed herein.

FIG. 6 illustrates a block diagram of an example device in accordance with various aspects discussed herein.

FIG. 7 illustrates a block diagram of an example computing system in accordance with various aspects discussed herein.

FIG. 8 illustrates a machine learning and training model in accordance with various aspects discussed herein.

FIG. 9 illustrates a computing system in accordance with various aspects discussed herein.

FIG. 10 is an exemplary flowchart of an example method 1000 in accordance with exemplary aspects of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

The present disclosure may be understood more readily by reference to the following detailed description taken in connection with the accompanying figures and examples, which form a part of this disclosure. It is to be understood that this disclosure is not limited to the specific devices, methods, applications, conditions, or parameters described and/or shown herein, and that the terminology used herein is for the purpose of describing particular embodiments by way of example only and is not intended to be limiting of the claimed subject matter.

Some examples of the present disclosure will now be described more fully hereinafter with reference to the accompanying drawings, in which some, but not all examples of the present disclosure are shown. Indeed, various examples of the present disclosure may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received and/or stored in accordance with examples of the invention. Moreover, the term “exemplary,” as used herein, is not provided to convey any qualitative assessment, but instead merely to convey an illustration of an example. Thus, use of any such terms should not be taken to limit the spirit and scope of examples of the present disclosure.

As defined herein a “computer-readable storage medium,” which refers to a non-transitory, physical, or tangible storage medium (e.g., volatile, or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional virtual worlds, online games (e.g., video games), one or more content items such as, for example, images, videos, non-fungible tokens (NFTs) and in which the content items may, for example, be purchased with digital currencies (e.g., cryptocurrencies) and/or other suitable currencies. In some examples, a Metaverse or Metaverse network may enable the generation and provision of immersive virtual spaces in which remote users may socialize, collaborate, learn, shop, and engage in various other activities within the virtual spaces, including through the use of Augmented/Virtual/Mixed Reality.

References in this description to “an example,” “one example,” or the like, may mean that the particular feature, function, or characteristic being described is included in at least one example of the present invention. Occurrences of such phrases in this specification do not necessarily all refer to the same example, nor are they necessarily mutually exclusive.

Also, as used in the specification including the appended claims, the singular forms “a,” “an,” and “the” include the plural, and reference to a particular numerical value includes at least that particular value, unless the context clearly dictates otherwise. The term “plurality,” as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

In various aspects, systems, methods, devices, and computer program products may provide interfaces (e.g., a user interface) to generate tailored content. The techniques and aspects discussed herein differentiate and improve upon conventional systems, at least by generating content using a set of interests and recipes to create an individualized, tailored output.

A recipe, as described herein, may refer to a set of elements, e.g., a set of content characteristics, that the generated content may have/include. Recipes may be manually defined and/or automated (e.g., automatically determined/generated), and may include, for example, a set of elements comprising one or more content characteristics. For purposes of illustration and not of limitation, some example recipes may be a “historical place and time period” or “instructions and food” or a “cultural event.” The recipe(s) and the user's interests may then be utilized to create the generated content. Such generated content may be based on user activity, such as online activity, social media activity, user profiles, likes, clicks, posts, shares, and other Internet-based information associated with the user. In examples, systems and methods may include an interface (e.g., a user interface) to enable user input, such as entered text or a recipe selection. The interface may then generate the tailored content based on the input.

Relevance of generated content may be determined based on user interests as well as user input providing guidance, which may be incorporated into one or models (e.g., machine learning model(s) 810) discussed herein. Relevance may be determined, for example, based on personalization (e.g., content specifically relevant to the user), public figures (e.g., celebrities, notable individuals), popular content (e.g., books, movies, videos, etc.), cultural moments (e.g., holidays, sporting events, etc.), and any combination of the above.

Generated content may be delivered directly into existing content feeds, such as feeds on social media sites. The tailored content may be seamlessly incorporated into user's content consumption and online activities to promote interactions and engagement. Such content may also be shareable, to encourage connections with existing friends and contacts, while increasing value and interest to the user's online experience.

Various aspects may include an automated interface, such as an interactive box, e.g., within a content feed, or otherwise on a website, and one or more machine learning models (e.g., machine learning model(s) 810) to assist with content generation, recipes, interest determinations, and general operation. Machine learning models (e.g., machine learning model(s) 810) may assist with recommending and generating text, copy, imagery, and videos via user input. Such interfaces and features may be incorporated on and/or accessible via a web page or application, for example. Generated content may be modifiable to enable further customization, and published via an online platform, such as a social media network, or other medium. As a result, generated tailored content may seamlessly blend with existing content, provide useful, relevant, and interesting information, and enable users to connect over unique content.

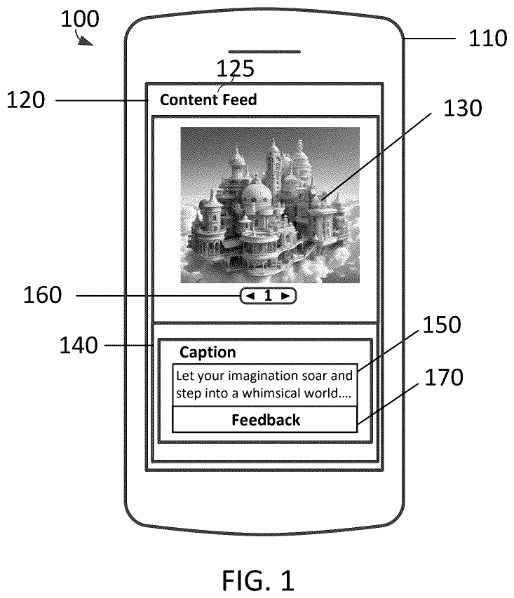

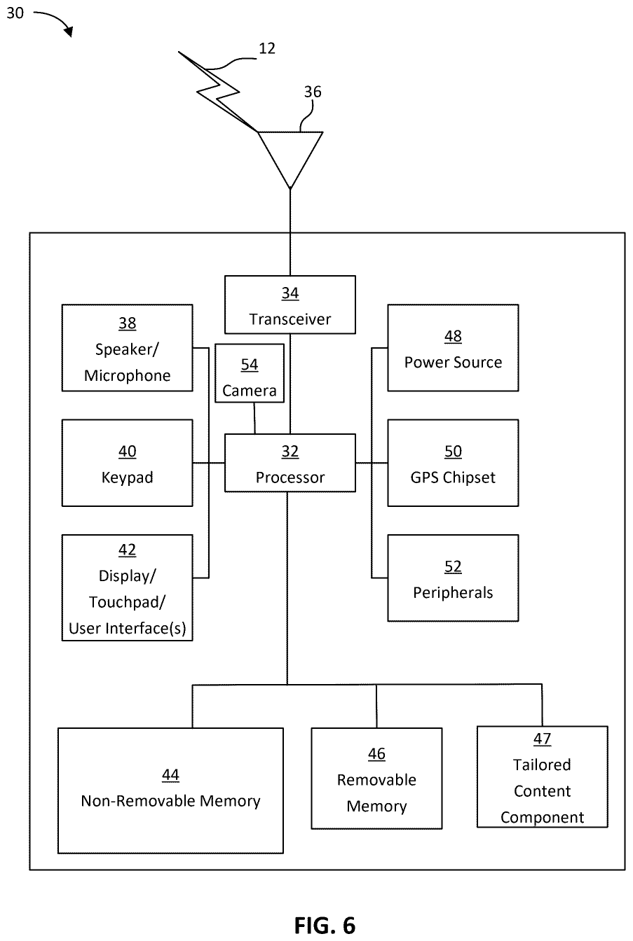

FIG. 1 illustrates an example system 100 and graphical user interface 120 for implementing generated tailored content systems and methods, in accordance with aspects discussed herein. The graphical user interface 120 may be provided on a display of a system 100, such as a computing system. The computing system may include a user device 110, such as a mobile device, smart phone, laptop, tablet, desktop computer, or another computing system providing a display and an Internet connection. In some examples, the user device 110 may be an example of User Equipment (UE) (e.g., UE 30 of FIG. 6). In examples, the graphical user interface 120 may be provided on a website accessible on a browser via the computing device and/or mobile device.

A content feed 125 may display one or more content items to the user. The content items may be, for example, a picture, video, reel, graphics interchange format (GIF), and/or post. In a social media content feed, for example, content feed 125 may display a mix of posts from friends of the user, associated profiles, businesses, brands, influencers, channels, and pages associated with the social media site. The displayed content may be curated based on associations with the user (e.g., followed friends, pages, etc.) and subjects of interest to the user. A user may scroll and/or swipe through the content feed 125 to continue viewing content.

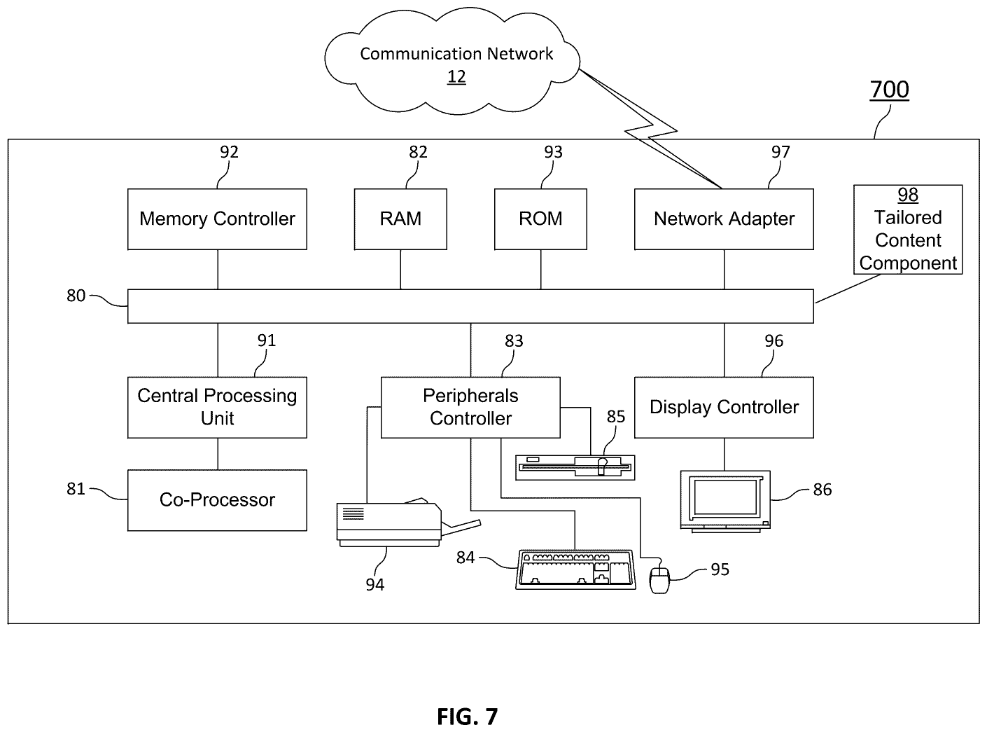

Aspects of the present disclosure may incorporate generated content 140 into the content feed 125. In some examples, a tailored content component (e.g., tailored content component 47 of FIG. 6, tailored content component 98 of FIG. 7) may incorporate the generated content 140 into the content feed 125. The generated content 140 may include at least one of an image 130 and a caption 150 associated with the image. As discussed herein, the generated content 140 may be curated for the particular user so that the generated content 140 is tailored to the user's interests. Interests may be obtained, for example, based on the user's online activity, such as social media activity, a social media profile, likes, posts, views, follows, interactions, etc. For example, the associated user profile may provide information relating to one or more of posts, comments, text, images, videos, likes, watches, friends, and/or interactions, which may be helpful to provide insight relating to the user's interests. Such information may be utilized via one or more machine learning models (e.g., machine learning model(s) 810), along with any obtained user input.

The generated content 140 may be generated using the user's interests along with a recipe. In some examples, the user's interests may include a list of the “Top N” topics that the user is interested in. A recipe includes a set of content characteristics, which may be, for example, one or more of a time period(s), a place(s), an aesthetic(s), an interest(s), a character(s), and/or a cultural moment(s). The content characteristics may describe elements to be incorporated into the generated content. Such content characteristics may be randomly selected (e.g., by tailored content component 47, or tailored content component 98) or correspond to a user interest.

In the example of FIG. 1, the user may be interested in a particular type of architecture, e.g., Belle Epoque architecture and fantasy. Such interests may be inferred (e.g., by tailored content component 47, or tailored content component 98), for example, based on the user's activity and interactions with other posts, profiles, and pages related to those topics. The generated content 140 may therefore incorporate the interest (e.g., architecture and fantasy) along with a recipe including content characteristics directed to a particular place and time period. As a result, the image 130 reflects those interests, the set of content characteristics associated with a recipe (e.g., place and time period), and creates an imaginative picture and caption 150 intended to capture the user's interest. The generated content 150 may be provided (e.g., by tailored content component 47, or tailored content component 98) on the content feed 125 to maintain user interest and interaction with the content feed.

The generated content 140 may further provide a selection 160 to initiate generation of additional, related tailored content. The selection 160 may provide arrows, numbers, letters, and/or other symbols to indicate that additional content is available. Selection 160, for example, may generate new tailored content related to architecture, fantasy, a particular place, and a time period. For purposes of illustration and not of limitation, in some examples, a number (e.g., such as three) of tailored content (e.g., images and/or captions) may be created (e.g., by tailored content component 47, or tailored content component 98) at one time so that a user may easily look between the different options. In another example, a user input may load new tailored content. In some examples, the user input may include one or more of a gesture(s), swipe(s) (e.g., left swipe, right swipe, up swipe, down swipe, etc.), selection(s), tap(s), pattern(s), audio input(s) (e.g., voice input(s), voice-activated feature(s)), or any other type, method, or manner in which user input may be received as user content.

In additional examples, a feedback box 170 may be provided (e.g., by tailored content component 47, or tailored content component 98) to receive feedback, via text or a selection for a user to describe or refine the type of content they may like to see. For example, a user may enter in feedback box 170 that they may like to see a different type of architecture, time period, or place, reflected in image 130. In some examples, the feedback box 170 may provide prompts, such as “See More,” “New Caption,” or text related to another topic. Such selections may allow a user to choose how they may like to further tailor a next set of generated content 140. In some examples, selecting feedback generates a pre-defined number of new content items, such as for example three new pictures that may be rotated, e.g., via selection 160.

It should be appreciated that the layout of interfaces on the user device 110 include, but are not limited, to shape, color, design, and placement of various aspects, such as features (e.g., elements 120, 130, 140, 150, 160, and 170) may be changed based on design considerations, featured content, content feed layout, web page layout, available space, desired editing options, and the like.

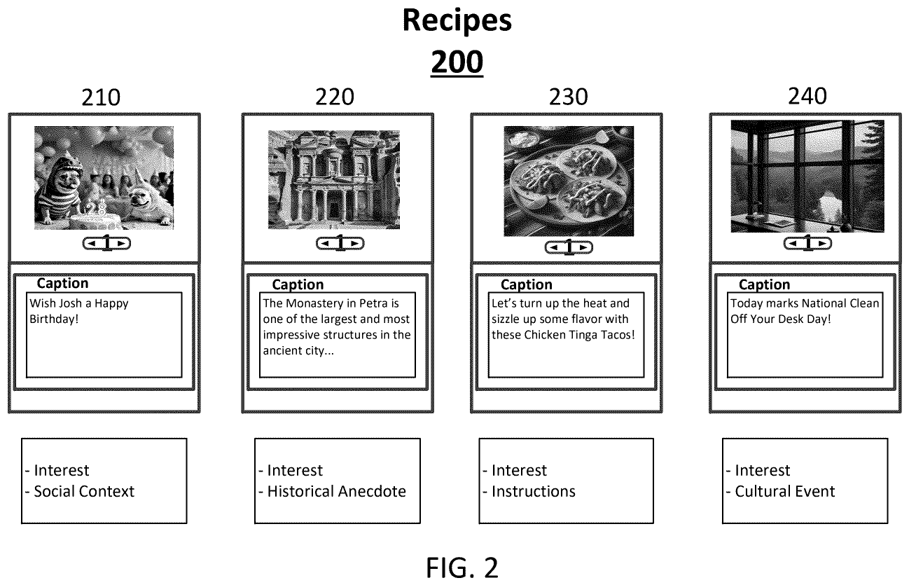

FIG. 2 illustrates examples of generated content associated with various recipes 200. Recipes 200 may include one or more content characteristics to be incorporated into generated content. In examples, content characteristics may include an interest, a social context (e.g., a birthday), a cultural event (e.g., a holiday), a historical anecdote, instructions (e.g., “how to” or “step-by-step” instructions). Recipes may include any combination of content characteristics. In some examples, recipes may be predetermined sets of content characteristics, and may be used to train one or more machine learning models (e.g., machine learning model(s) 810) to generate tailored content. In some examples, users may be able to define recipes, thus furthering the tailored content generated on their content feed.

Recipes may be updated and curated (e.g., by tailored content component 47, or tailored content component 98) to increase interest and interactions with a user. Some users may receive certain types of recipes more often than others if their interests indicate an affinity towards certain types of content. In other words, a user's interests (e.g., based on their content consumption, online activity, etc.) may indicate a higher interest in certain types of recipes. For example, a user who enjoys cooking and food may receive a recipe 200 that combines those interests with a specific content characteristic (e.g., instructions). As a result, the user may receive tailored content directed towards how to cook certain dishes or cuisines. The receipt of the tailored content by the user may be generated and provided to the user by a tailored content component (e.g., tailored content component 47, tailored content component 98).

In one example, content 210 represents generated, tailored content for a recipe 200 with content characteristics including an interest and a social context. The interest for a user may be “dogs” and the social context may be “birthday.” The set of attributes associated with the user may indicate that a friend of the user has a birthday in the near future. A tailored content component (e.g., tailored content component 47, tailored content component 98) may cause content 210 to incorporate that information, along with a user interest (e.g., dogs) to generate an image for the user providing a visual representation of the set of content characteristics influenced by the set of attributes. As a result, a tailored content component may provide content 210 of an image of dogs at a birthday party, and a caption directed to wishing the user's friend a happy birthday.

In some examples, a recipe(s) may be associated with decisions and/or instructions. For example, the recipe associated with content 210 may include instructions to a machine learning model(s) (e.g., machine learning model(s) 810) defining the space of ideas the machine learning model(s) may utilize to represent “happy birthday” visually. Additionally, in some examples, the machine learning model(s) and its inputs and outputs may be mediated by logic. For instance, an upcoming birthday of a user may trigger a birthday recipe by the machine learning model(s).

In another example, content 220 illustrates generated, tailored content (e.g., by tailored content component 47, or tailored content component 98) for a recipe 200 combining an interest with a historical anecdote. The user, for example, may be interested in a particular place, time period, historical figure, or other historical event. In this example, the user may have indicated interest, via their content consumption, in Petra. The tailored content 220 reflects this through an image displaying the Monastery in Petra, and a caption providing information or other “fun facts” about the place. As discussed above, a set of tailored content may be generated, and by swiping left/right, or other feedback, similar content (e.g., historical facts related to a place or period of interest to the user) may be generated (e.g., by tailored content component 47, or tailored content component 98) and displayed on a graphical user interface of a user device (e.g., user device 110).

In yet another example, content 230 illustrates tailored content generated from a recipe 200 combining a user interest with instructions. In some examples, the content 230 illustrating the tailored content generated from the recipe 200 may be generated by a tailored content component (e.g., by tailored content component 47, or tailored content component 98). This user, like the example provided above, may be interested in cooking and food. Content 230 may reflect this interest by providing an image of Chicken Tinga Tacos and a caption directed towards making the tacos. In some examples, the caption may provide step-by-step instructions, or a link to a recipe or website likely to be of interest to the user.

Content 240 illustrates an example of a recipe relating to an interest and cultural event. In some examples, a tailored content component (e.g., tailored content component 47, or tailored content component 98) may generate the content 240. The cultural event may be a holiday or other event associated with an interest of the user. In the illustrated example, the cultural event is “National Clean Off Your Desk Day” and an image and caption may be curated (e.g., by tailored content component 47, or tailored content component 98) for a user whose content consumption indicates an interest in such content.

It should be appreciated that these recipes combinations, interests, and generated tailored content are non-limiting examples to convey how content characteristics may be combined with one or more user interests to generate tailored content relevant to the user and their interests. Any of a plurality of recipes, including various combinations and types of content characteristics, may be provided in accordance with aspects discussed herein.

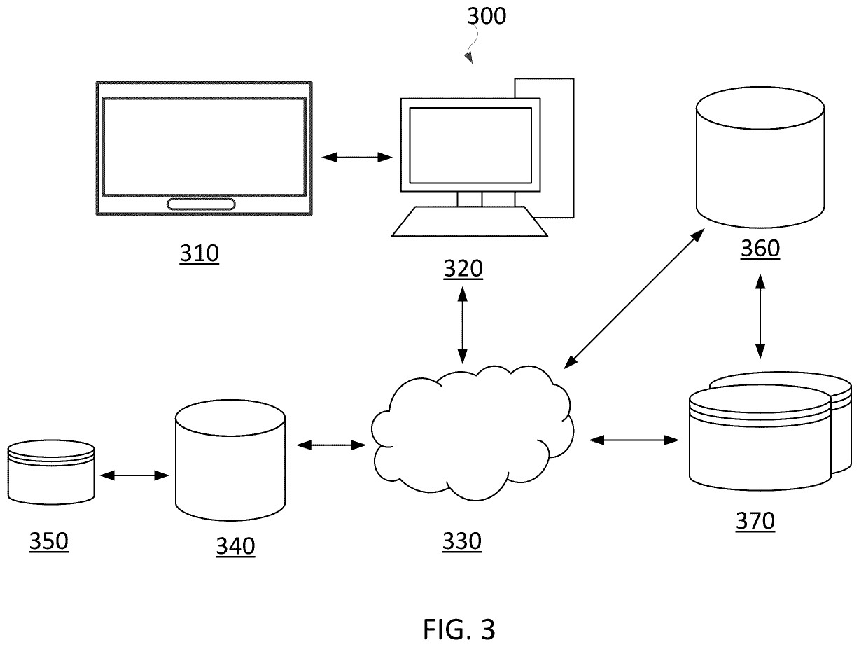

FIG. 3 illustrates a diagram for data processing and networking communications, in accordance with aspects discussed herein. A system 300 of FIG. 3 may include a graphical user interface 310 that may receive user input and display content. The graphical user interface 310 may be associated with a computing system 320 (e.g., computing system 700 or computing system 900). In some examples the computing system 320 is a user device (e.g., user device 110). The computing system 320 may communicate with a network 330, which may be a cloud network, in remote communication with one or more storage systems (e.g., databases 340, 360), and machine learning models (e.g., machine learning model 350).

An interests database 340 may include information associated with one or more users. Such information may include a first set of attributes associated with a first user. In examples, the first user's content consumption may have been tracked (e.g., activity associated with a website, content, social media, etc.) and analyzed via one or more machine learning models, such as machine learning model 350. The first set of attributes may be stored in the interests database 340. In some examples, the machine learning model 350 may be an example of machine learning model(s) 810.

A recipes database 360 may include information defining one or more recipes. Each of the recipes may include a set of content characteristics, as discussed herein. The recipes may be pre-defined (e.g., predetermined) based on user input. A machine learning model 370 (e.g., machine learning model(s) 810) may obtain information from the recipes database 360 and retrieve a set of attributes (e.g., the first set of attributes associated with the first user) from the interests database 340 to generate a visual representation of the recipe (i.e., a set of content characteristics influenced by the set of attributes. In examples, the machine learning model 370 may further generate the tailored content to be sent to computing system 320 via network 330, for display on the graphical user interface 310.

In various examples, machine learning model 370 may include one or more models (e.g., machine learning model(s) 810) to generate the visual representation and the tailored content. For example, a machine learning model may be usable to generate tailored video content, whereas another machine learning model may be usable to generate images, and yet another machine learning model may be usable to generate text associated with the tailored content. One or more models (e.g., machine learning models) may assist with generating variations of the tailored content. Various combinations of machine learning models and software modules may be usable in accordance with aspects discussed herein.

In an example, the user's interests and recipe (e.g., content characteristics) may be collected and provided to a machine learning model. The model may generate seed content (e.g., the visual representation) including a set of images that may make up an initial post, based on the user's interests and recipes. The seed content may be a set number of images (e.g., N #variant images, a baes image, etc.), and may be utilized to generate the tailored content (e.g., a personalized post). In one example, a user may indicate a selection to view more images. The selection may include a “fork” to indicate whether to add or change a content characteristic to the post. A “fork” or “forking” may refer to user input (e.g., entered text, a selection, etc.) to adjust or refine an interest, and/or content characteristic for a next set of tailored content. The new content characteristic may be based on a description, e.g., entered by the user, defining an interest of a content characteristic(s). In such cases, new seed content may be generated (e.g., by tailored content component 47 or tailored content component 98), along with a new post. In another example, the new content characteristic may be related to one or more of the user's interests, the set of attributes, and the set of content characteristics. For example, the set of content characteristics may include a historical place and time period. The new content characteristic may be a different historical place or a different time period. The new content characteristic may be a different time period based on a description from the user, entered at the graphical user interface (e.g., graphical user interface 310).

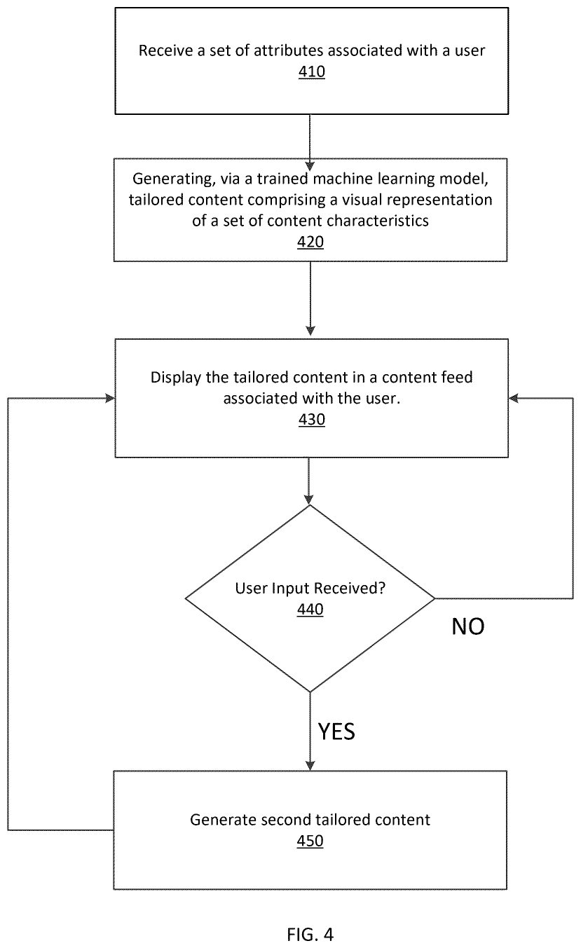

According to an aspect, FIG. 4 illustrates a flow chart for generating tailored content. At block 410, aspects may receive a set of attributes associated with a user. The set of attributes may be indicative of user interests based on content consumption of the user. The content consumption may be based on user activity, such as online activity including but not limited to browsing, social media activity, posts, likes, friends, comments, and the like. One or more local or remote machine learning models (e.g., machine learning model 350) may be utilized to generate the set of attributes associated with the user.

At block 420, a device (e.g., tailored content component 47 or tailored content component 98) may generate, via a trained machine learning model, tailored content comprising a visual representation of a set of content characteristics. In examples, the trained ML model may employ a recipe comprising the set of content characteristics. The ML model may employ the recipe in view of the set of attributes. The tailored content may therefore represent the set of content characteristics influenced by the set of attributes. The tailored content may be generated using one or more machine learning models (e.g., machine learning model 370, machine learning model(s) 810).

At block 430, a device (e.g., tailored content component 47 or tailored content component 98) may display the tailored content in a content feed associated with the user. The content feed (e.g., content feed 125) may be provided on a graphical user interface (e.g., graphical user interface 120) of a user device (e.g., user device 110).

At block 440, a device (e.g., tailored content component 47 or tailored content component 98) may determine whether user input has been received. Such user input may be provided at a user interface (e.g., graphical user interface 310) of a user device (e.g., user device 110). In some examples, the user input may indicate a selection (e.g., via selection button 160) or feedback (e.g., via feedback box 170) to generate second tailored content.

If no user input has been received, the content may remain displayed in the content feed associated with the user. At block 450, if user input has been received, a device (e.g., tailored content component 47 or tailored content component 98) may generate second tailored content. The second tailored content may be a new set of content associated with the interest and recipe of the first tailored content. In another example, the second tailored content may incorporate or change at least one new interest or content characteristic from the first tailored content. The second tailored content may also be updated based on feedback (e.g., via feedback box 170) provided via the graphical user interface (e.g., display of user device 110). In other examples, the second tailored content may be generated as a result of a selection provided on the graphical user interface (e.g., selection 160), which when selected, may show variations of the first tailored content. The selection on the graphical user interface (e.g., selection 160) may also provide options for variation, noting, for example, incorporation of a different interest, content characteristic, recipe type, or other element of the tailored content. The second tailored content may then be displayed in the content feed associated with the user (e.g., block 430).

Operations of blocks 410, 420, 430, 440, and 450 may occur separately, independently, and/or concurrently with one or more other operations of blocks 410, 420, 430, 440, and 450. Such operations may also occur on one or more computing devices, depending on design considerations and system architectures with one or more other operations.

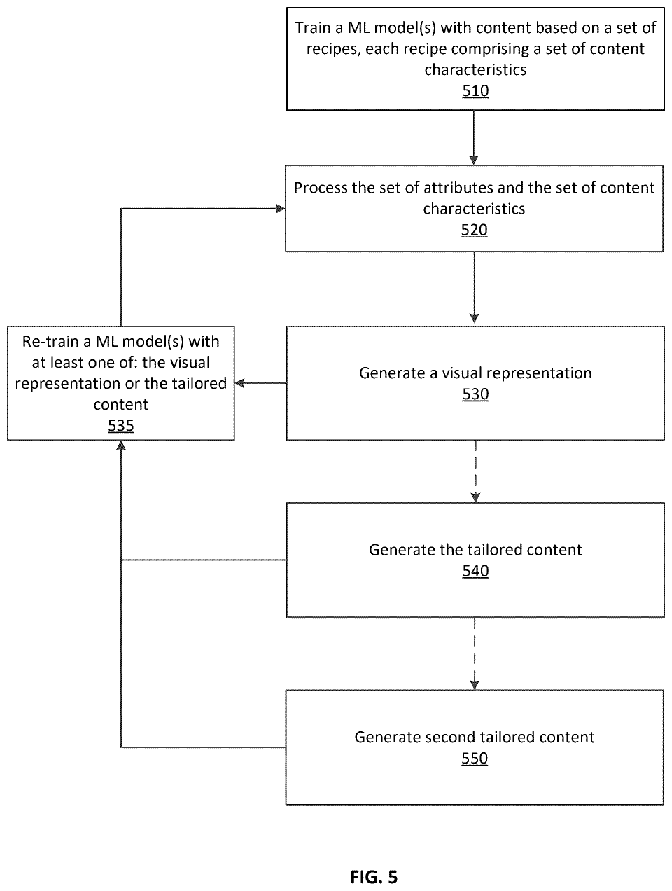

According to a further aspect, FIG. 5 illustrates a flow chart for one or more machine learning models (e.g., machine learning models 350, 370, 810) generating tailored content. At block 510, a device (e.g., tailored content component 47 or tailored content component 98) may train a ML model(s) with content (e.g., training data) based on a set of recipes (e.g., recipes 200). Each recipe, of the set of recipes, comprising a set of content characteristics. The content characteristics may include, but are not limited to, a social context, historical anecdote, instructions, cultural event, time period, place, architecture, or other content characteristic as discussed in FIG. 1 and FIG. 2.

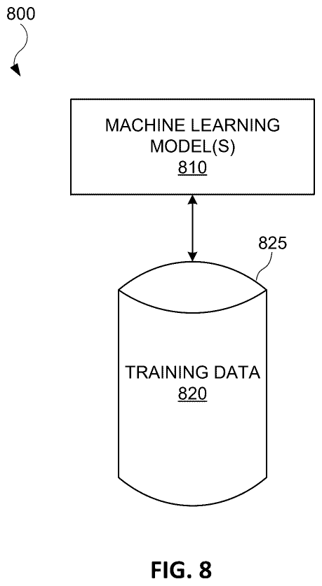

At block 520, a device (e.g., tailored content component 47 or tailored content component 98) may process the set of attributes and the set of content characteristics. The set of attributes may be indicative of user interests based on content consumption of the user. Processing the set of attributes and the set of content characteristics may be performed via one or more training data operations as discussed below, in FIG. 8. Such processing may include determining any associations between the set of attributes and the set of content characteristics, determining text, image, or other visual characteristics likely to be relevant and interesting to the user.

At block 530, a device (e.g., tailored content component 47 or tailored content component 98) may generate a visual representation. The visual representation may reflect the set of content characteristics influenced by the set of attributes. The visual representation may include a type of content, such as an image, video, graphics interchange format (GIF), reel, animation, or other visual representation. In some examples, generating the visual representation may include determining one or more characteristics of the tailored content, such as incorporation of a character, place, image, or other element. In examples, the character may be a user-generated character, an avatar, or other object associated with the user, the user's profile, or with the user's online activity and content consumption. For example, a user's character may be a custom avatar, which may be user-generated or computer generated. Generating the visual representation (e.g., by the tailored content component 47 or tailored content component 98) may include incorporating aspects of the character, such as a look, feel, characteristic, personality trait, or other identifying element of the character.

At block 540, a device (e.g., tailored content component 47 or tailored content component 98) may generate the tailored content. In some other examples, the tailored content may be generated locally, e.g., with a same computing system or machine learning model generating the visual representation. In other examples, the tailored content may be sent (e.g., via network 330) to one or more remote computing systems to generate the tailored content based on the visual representation. Any of a plurality of computing system architectures, networking, and data processing setups may be utilized in accordance with aspects discussed herein.

At block 550, a device (e.g., tailored content component 47 or tailored content component 98) may generate a second tailored content. The second tailored content may be generated, for example, in response to user input received at a graphical user interface. The user input may be a selection (e.g., via selection 160, feedback box 170). In some examples, the second tailored content operation may not necessarily occur, and the second tailored content may be generated in response to one or more actions occurring (e.g., user input, content feed refresh, etc.).

At block 535, a device (e.g., tailored content component 47 or tailored content component 98) may re-train a ML model(s) with at least one of the visual representation or the tailored content (e.g., first tailored content, the second tailored content, etc.). As described herein, the content may be based on a recipe (e.g., recipes 200), which may include one or more content characteristics associated with the recipe. In some examples, engagement rate, sharing rate, user input information, and others may be feedback incorporated into one or more models. Since one or more machine learning models may be usable, different machine learning models may be trained with different sets of data (e.g., training data). The tailored content and recipes may provide feedback to models (e.g., machine learning models 350, 370, 810) to re-train and refine the models to create more accurate, relevant, and interesting content to the user. The re-training may also provide information regarding which content a user(s) found interesting, such as which generated content the user(s) interacted with most or least, a length of time of interactions or engagements, and other characteristics, such as whether the user shared, clicked, or otherwise interacted or engaged with the content.

Operations of blocks 510, 520, 530, 535, 540, and 550 may occur separately, independently, and/or concurrently with one or more other operations of blocks 510, 520, 530, 535, 540, and 550. Such operations may also occur on one or more computing devices, depending on design considerations and system architectures.

FIG. 6 illustrates a block diagram of an example hardware/software architecture of a UE 30. As shown in FIG. 4, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, a tailored content component 47, and other peripherals 52. The UE 30 may also include a camera 54. In an example, the camera 54 may be a smart camera configured to sense images appearing within one or more bounding boxes. The UE 30 may also include communication circuitry, such as a transceiver 34 and a transmit/receive element 36. It should be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another embodiment, the transmit/receive element 36 may be configured to transmit and receive both RF and light signals. It should be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCad), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It should be appreciated that the node 30 may acquire location information by way of any suitable location-determination method while remaining consistent with an example.

The tailored content component 47 may determine a set of attributes associated with one or more users. The set of attributes may be indicative of user interests based on determined content consumption of the one or more user. In some examples, the tailored content component 47 generate one or more items of tailored content that may include a visual representation of a set of content characteristics determined or influenced by the set of attributes. The tailored content component 47 may present the one or more items of tailored content to be displayed, by a graphical user interface (e.g., the display, touchpad, and/or indicators 42), in a content feed associated with the one or more users. Other aspects and features of the tailored content component 47 may be discussed above.

In some examples, the tailored content component 47 may implement, or may be, a machine learning model(s) (e.g., machine learning models 350, 370, 810). The machine learning model(s) may utilize training data (e.g., training data 820) that may employ one or more recipes comprising one or more sets of content characteristics associated with one or more users.

FIG. 7 is a block diagram of a computing system 700 which may also be used to implement components of the system (e.g., system 100, system 300) or be part of the UE 30 or the computing system 320. The computing system 700 may comprise a computer or server and may be controlled primarily by hardware. In other examples, the computer system 700 may be controlled in part by computer readable instructions, which may be in the form of software, wherever, or by whatever means such software is stored or accessed. Such computer readable instructions may be executed within a processor, such as central processing unit (CPU) 91, to cause computing system 700 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 700 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 contain stored data that may not easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 700 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 700. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 700 may contain communication circuitry, such as for example a network adaptor 97, that may be used to connect computing system 700 to an external communications network, such as network 12 of FIG. 6, to enable the computing system 700 to communicate with other nodes (e.g., UE 30) of the network.

The computing system 700 may also include a tailored content component 98. In some examples, the tailored content component 98 may operate/function in a similar fashion as described above with regards to the tailored content component 47.

FIG. 8 illustrates a framework 800 employed by a software application (e.g., computer code, a computer program) to generate tailored content in accordance with aspects discussed herein. The framework 800 may be hosted remotely. Alternatively, the framework 800 may reside within the UE 30 shown in FIG. 6 and/or may be processed by the computing system 700 shown in FIG. 7. The machine learning model(s) 810 may be operably coupled to the stored training data 820 in a database 825 (e.g., database 340, 360). In some examples, the machine learning model(s) 810 may be associated with operations (or performing operations) of FIGS. 4, 5 and 10. In some other examples, the machine learning model(s) 810 may be associated with other operations.

In some exemplary aspects, an example of training data 820 utilized by the machine learning model(s) 810 to generate tailored content may be words describing an image(s), video(s), or the like and/or the image data and the video data itself. Additionally, the training data 820 of the machine learning model(s) 810 may include determined interests of users as embeddings, and/or engagement/interactions of the users, associated with a platform (e.g., system 300), to generate outputs (e.g., generated tailored content). In some examples, the engagement/interactions of the users may, but need not, be associated with engagements/interactions by the users with content (e.g., messages, posts, feeds, likes, etc.) associated with a platform.

In an example, the training data 820 may include attributes of thousands of objects. For example, the object(s) may be identified and/or associated with user profiles, posts, likes, clicks, reels, photographs, images, videos, interactions, web pages, graphics interchange formats (GIFs), online content, and/or the like. Attributes may include but are not limited to content, interests, text, colors, color schemes, aesthetics, time periods, cultural events, social contexts, etc. The training data 820 employed by the machine learning model(s) 810 may be fixed or updated periodically. Alternatively, the training data 820 may be updated in real-time based upon the evaluations performed by the machine learning model(s) 810 in a non-training mode. This is illustrated by the double-sided arrow connecting the machine learning model(s) 810 and stored training data 820.

In operation, the machine learning model 810 may evaluate attributes of images, videos, reels, posts, likes, interactions, web pages, and other media obtained by hardware (e.g., UE 30, computing system 320, computing system 700, computing system 900, etc.). For example, aspects of a user profile, videos, reels, posts, likes, interactions, web pages and/or the like may be ingested and analyzed by the machine learning model(s) 810. The attributes of any of the above (e.g., captured image(s) of an object(s), post(s), text, user attribute(s), interest(s), profile attribute(s), characteristic(s), etc.) may then be compared with respective attributes of stored training data 820 (e.g., prestored objects). The likelihood of similarity between each of the obtained attributes (e.g., of a captured image(s) and/or text) and the stored training data 820 (e.g., prestored objects) may be provided a determined confidence score. In one example, in an instance in which the confidence score exceeds a predetermined threshold, the attribute(s) may be included in an image description that is ultimately communicated to the user via a user interface of a computing device (e.g., UE 30, computing system 320, computing system 700, computing system 900, etc.). In another example, the description may include a certain number of attributes which exceed a predetermined threshold to share with the user. The sensitivity of sharing more or less attributes may be customized based upon the needs of the particular user.

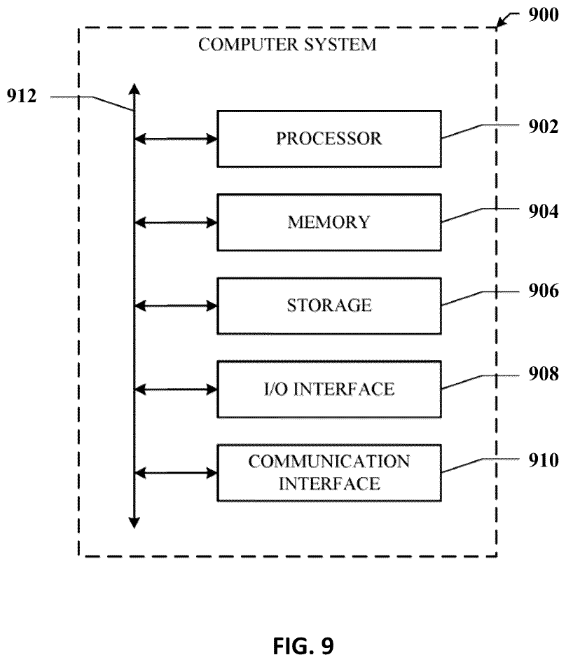

FIG. 9 illustrates an example computer system 900 according to exemplary aspects of the present disclosure. In examples, one or more computer systems 900 perform one or more steps of one or more methods described or illustrated herein. In particular embodiments, one or more computer systems 900 provide functionality described or illustrated herein. In examples, software running on one or more computer systems 900 performs one or more steps of one or more methods described or illustrated herein or provides functionality described or illustrated herein. Examples include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example, and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In examples, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In examples, processor 902 includes hardware for executing instructions, such as those making up a computer program. As an example,—and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example, and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In examples, memory 904 includes main memory for storing instructions for processor 902 to execute or data for processor 902 to operate on. As an example, and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In examples, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In examples, storage 906 includes mass storage for data or instructions. As an example, and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In examples, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In examples, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example, and not by way of limitation, an I/O device may include a keyboard, keypad, microphone, monitor, mouse, printer, scanner, speaker, still camera, stylus, tablet, touch screen, trackball, video camera, another suitable I/O device, or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In examples, communication interface 910 includes hardware, software, or both providing one or more interfaces for communication (such as, for example, packet-based communication) between computer system 900 and one or more other computer systems 900 or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example, and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

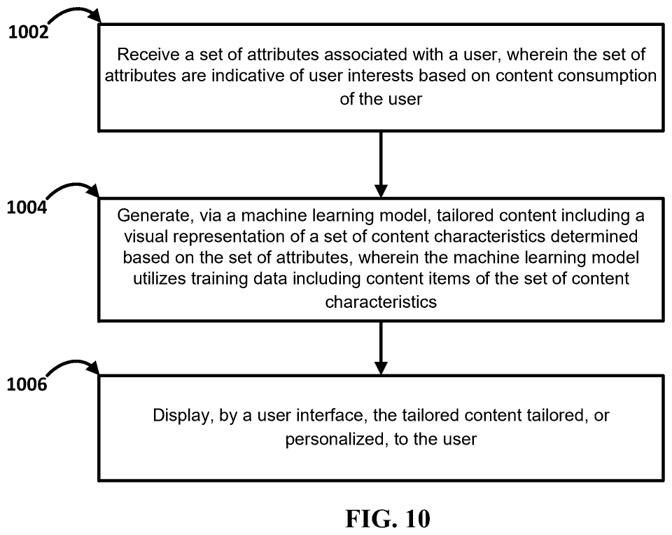

FIG. 10 is a flowchart of an example method 1000 in accordance with exemplary aspects of the present disclosure. At operation 1002, a device (e.g., tailored content component 47, tailored content component 98) may receive a set of attributes associated with a user. The set of attributes may be indicative of user interests based on content consumption of the user. The content consumption may be associated with one or more interests of the user associated with a network, platform (e.g., system 300), or the like and/or one or more user interactions with content items and/or user engagements with the content items on, or associated with, the network, platform, or the like.

At operation 1004, a device (e.g., tailored content component 47, tailored content component 98) may generate, via a machine learning model(s), tailored content (e.g., generated content 140) including a visual representation of a set of content characteristics (e.g., image 130, caption 150, feedback box 170) determined based on the set of attributes. The content characteristics may be determined based on the set of attributes. In this regard for purposes of illustration and not of limitation, for example, if one of the attributes was “likes beaches”, the content characteristics may relate to a parasol on a boardwalk, a meme about sand, and/or a sunset over the ocean. In some examples, the defining of the set of content characteristics may be based on determining a location of a user and/or determined user interest data.

The machine learning model(s) (e.g., machine learning models 350, 370, 810) may utilize training data (e.g., training data 820) including content items of the set of content characteristics. At operation 1006, a device (e.g., tailored content component 47, tailored content component 98) may display, by a graphical user interface (e.g., graphical user interface 120), the tailored content, tailored or personalized to the user. In some examples, the display of the tailored content may be presented by a content feed (e.g., content feed 125) associated with the user.

Although FIG. 10 shows example operations of method 1000, in some exemplary aspects, method 1000 may include additional operations, fewer operations, different operations, or differently arranged operations than those depicted in FIG. 10. Additionally, or alternatively, two or more of the operations of method 1000 may be performed in parallel.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed:

1. A method comprising:
receiving a set of attributes associated with a user, wherein the set of attributes are indicative of user interests based on content consumption of the user;
generating, via a machine learning model, tailored content comprising a visual representation of a set of content characteristics determined based on the set of attributes, wherein the machine learning model utilizes training data comprising content items of the set of content characteristics; and
displaying, by a user interface, the tailored content tailored to the user.

2. The method of claim 1, wherein the displaying comprises displaying, by the user interface, the tailored content in a content feed associated with the user.

3. The method of claim 1, wherein prior to the generating the tailored content, the method further comprises:
training the machine learning model with the training data based on the set of content characteristics, wherein the set of content characteristics define one or more different characteristics of the visual representation.

4. The method of claim 1, further comprising:
generating a second tailored content item in response to user input by the user interface, wherein the second tailored content item comprises at least one variation of the tailored content.

5. The method of claim 1, further comprising:
providing a selection within, or associated with, the content feed to update the tailored content; and
updating the tailored content by including a new content characteristic in the visual representation, in response to detecting an initiation of the selection.

6. The method of claim 5, wherein the selection provides at least one of a prompt indicating at least one modification to the tailored content, a box to receive information, input received by the user interface, or content describing the at least one modification of the tailored content.

7. The method of claim 1, further comprising:
defining the set of content characteristics based on determining a location of the user.

8. The method of claim 1, wherein the set of content characteristics comprises one or more of a time period, a place, an aesthetic feature, an interest, a character, or a cultural moment.

9. The method of claim 1, wherein the visual representation comprises at least one of an image, a video, a color scheme, or a social media post.

10. An apparatus comprising:
one or more processors; and
at least one memory storing instructions, that when executed by the one or more processors, cause the apparatus to:
receive a set of attributes associated with a user, wherein the set of attributes are indicative of user interests based on content consumption of the user;
generate, via a machine learning model, tailored content comprising a visual representation of a set of content characteristics determined based on the set of attributes, wherein the machine learning model utilizes training data comprising content items of the set of content characteristics; and
display, by a user interface, the tailored content tailored to the user.

11. The apparatus of claim 10, wherein the content consumption is associated with social media activity of the user.

12. The apparatus of claim 10, wherein the set of content characteristics comprises one or more of a time period, a place, an aesthetic feature, a character, or a cultural moment.

13. The apparatus of claim 10, wherein, prior to the generate the tailored content, when the one or more processors further execute the instructions, the apparatus is configured to:
train the machine learning model with the training data based on the set of content characteristics, wherein the set of content characteristics define one or more characteristics of the visual representation.

14. The apparatus of claim 10, wherein when the one or more processors further execute the instructions, the apparatus is configured to:
generate a second tailored content item in response to user input by the user interface, wherein the second tailored content item comprises at least one variation of the tailored content.

15. The apparatus of claim 10, when the one or more processors further execute the instructions, the apparatus is configured to:
update the tailored content, in response to user input, by including a new content characteristic in the visual representation.

16. A non-transitory computer readable medium storing instructions that, when executed cause:
receiving a set of attributes associated with a user, wherein the set of attributes are indicative of user interests based on content consumption of the user;
generating, via a machine learning model, tailored content comprising a visual representation of a set of content characteristics determined based on the set of attributes, wherein the machine learning model utilizes training data comprising content items of the set of content characteristics; and
displaying, by a user interface, the tailored content tailored to the user.

17. The non-transitory computer readable medium of claim 16, wherein the instructions when executed, further cause:
generating a second tailored content item in response to user input by the graphical user interface, wherein the second tailored content item comprises at least one variation of the tailored content.

18. The non-transitory computer readable medium of claim 16, wherein the instructions when executed, further cause:
updating the tailored content by including a new content characteristic in the visual representation.

19. The non-transitory computer readable medium of claim 16, wherein:
the set of content characteristics comprises one or more of a time period, a place, an aesthetic feature, an interest, a character, or a cultural moment; and
the visual representation comprises at least one of an image, a video, a color scheme, or a social media post.

20. The non-transitory computer readable medium of claim 16, wherein, prior to the generating the tailored content, the instructions when executed, further cause:
training the machine learning model with the training data based on the set of content characteristics, wherein the set of content characteristics define one or more different characteristics of the visual representation.
